(19) United States
(12) Patent Application Publication
(10) Pub. No.: US 2015/0195681 A1
(43) Pub. Date: Jul. 9, 2015

(54) Emergency Location and Communication System

(71) Applicant: Michael Flynn, Rancho Santa Fe, CA (US)

(72) Inventor: Michael Flynn, Rancho Santa Fe, CA (US)

(21) Appl. No.: 14/147,521

(22) Filed: Jan. 4, 2014

(51) Int. Cl. H04W 4/04; H04W 4/22

(52) U.S. Cl. CPC H04W 4/04; H04W 4/22

(57) ABSTRACT

An emergency communication system is provided that includes an RFID repeater that extends an RF signal within a structure, one or more RFID personnel devices that are carried by personnel within the structure, an RFID-equipped solar tower, and an RFID device reader. The solar tower includes a plurality of solar panels, a cellular repeater, a satellite backhaul, and an RFID antenna. The RFID reader displays the location of, and communicates with, the RFID personnel device(s) based on information received from the RFID device. The RFID personnel device further comprises a rechargeable battery, an RFID antenna, LED indicator light, SOS soft key and optionally a microphone, a speaker. In the event of an emergency, the SOS soft key is pressed to initiate Bluetooth communication with the user's cellular handset to make a 911 call using a cellular network or voice over internet protocol (VOIP) facilitated by the solar tower.

### RELATED U.S. APPLICATION DATA

This application claims priority to Provisional Application No. 61/754,240 filed Jan. 31, 2013.

### FIELD OF THE INVENTION

The present invention relates to personal emergency location and communication systems and devices.

### BACKGROUND OF THE INVENTION

Natural and manmade disasters such as fires, earthquakes, avalanches, cave-ins and tornadoes occur all over the world on a regular basis, and claim many lives. Often there are victims trapped within damaged or collapsed structures. Trapped victims often die or experience additional injury or suffering because their location is unknown and cannot be determined in time. These victims have no way to communicate with rescuers and rescuers often have no way to know the location and number of trapped individuals. With this critical information, rescuers could more effectively allocate resources and formulate rescue operations. Moreover, communication between trapped individuals and rescuers would provide more substantive and useful information to aid rescuers in understanding the specific state of health and environment of the trapped individual. There is a need in the art for an effective system that can assist with the location of, and communication with, individuals trapped in emergency situations to facilitate rescue.

### SUMMARY OF THE INVENTION

An emergency communication system is provided that includes an RFID repeater that extends an RF signal within a structure, one or more RFID personnel devices that are carried by personnel within the structure, an RFID-equipped solar tower, and an RFID device reader. The solar tower includes a plurality of solar panels, a cellular repeater, a satellite backhaul, and an RFID antenna. The RFID reader displays the location of, and communicates with, the RFID personnel device(s) based on information received from the RFID device. The RFID personnel device further comprises a rechargeable battery, an RFID antenna, LED indicator light, SOS soft key and optionally a microphone, a speaker. In the event of an emergency, the SOS soft key is pressed to initiate Bluetooth communication with the user's cellular handset to make a 911 call using a cellular network or voice over internet protocol (VOIP) facilitated by the solar tower.

### BRIEF DESCRIPTION OF THE DRAWINGS

FIG. 1 illustrates a side view of an RFID-enhanced solar tower and a perspective view of an RFID-ready building with RFID device-equipped occupants.

FIG. 2 illustrates a perspective view of an RFID personnel device.

FIG. 3 illustrates a perspective view of both a mobile RFID device reader and an RFID-ready building with RFID device-equipped occupants.

### DETAILED DESCRIPTION

The present invention provides an emergency communications system that acts as a safety communication network that can operate using existing cellular networks, or alternatively, operate independently off-the-grid. The key functionality is the emergency location of personnel within a structure that utilizes a novel, redundant web of RFID technology and associated hardware.

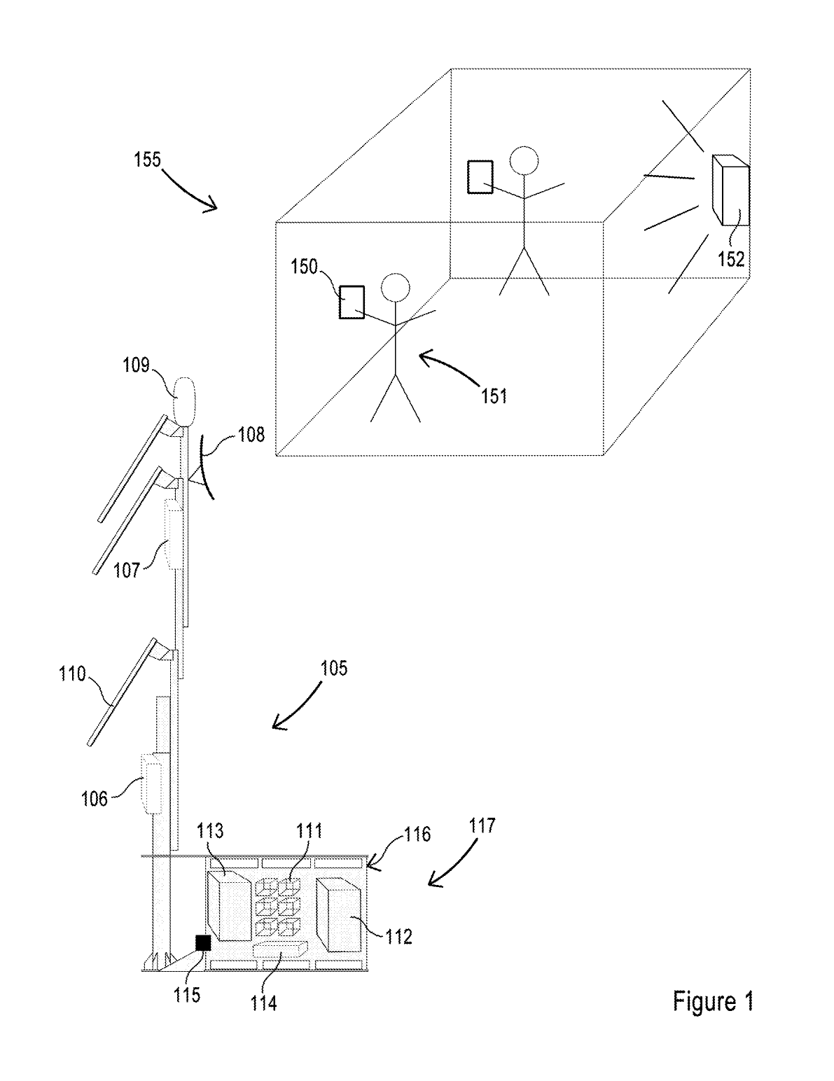

As FIG. 1 illustrates, the system includes an RFID-enhanced solar tower 105 (shown in a side view) and an RFID-ready building 155 having RFID device-equipped occupants 151. The RFID-enhanced solar tower 105 is a multi-tiered, adjustable structure that is stabilized by ballast unit 117. The use of a ballast allows the solar tower 105 to be mobile and eliminates the need for anchoring. Along its adjustable height, the solar tower includes a variety of communication components, including an SOS emergency call box 106, a plurality of solar panels 110, a cellular repeater 107, a satellite backhaul 108, and an RFID antenna 109. These are conventional components that are manufactured and installed as known in the art. At the base of solar tower 105, ballast unit 117 includes a protective ballast shell 116 that houses a plurality of batteries 111, a ballast weight 112, an optional generator and fuel unit 113, a power supply 114, and an optional connection device 115 for generator plug-in. The RFID solar tower 105 acts as an independent hotspot that can provide communications coverage in regions where no cellular coverage is available or as a backup when the cellular network is offline or disabled. The RFID solar tower supports communications where no backhaul or cellular coverage is available.

Emergency communication and location occurs via the RFID-enhanced solar tower in conjunction with the RFID system in place within a structure, i.e. building 155. The building occupants 151 within the building carry the RFID personnel device 150, and the internal RFID repeater 152 expands in-building RF signal coverage for more effective location of personnel. The RFID antenna 109 at the top of the tower 105 functions to wirelessly monitor the safety situations of individual building occupants 151 via their RFID personnel device 150. The RFID enhanced solar tower 105 can detect and “read” the personnel RFID devices 150 via RFID antenna 109. A computer system built-in or connected to the tower can log each of the RFID identification numbers and quickly identify the associated person. In an emergency situation, emergency personnel could man the RFID-enhanced solar tower and utilize the SOS emergency call box 106 to initiate two-way communication with trapped building occupants. Additionally the cellular repeater 107, used in conjunction with a satellite backhaul 108, could help propagate cellular coverage—a feature that also takes advantage of the RFID personnel device's plurality of communication options. This method would enhance the local cellular coverage to penetrate a structure which may be affected in its in-building coverage due to the collapse of building materials wherein existing cellular network coverage may be blocked or degraded. The wireless networks that existed prior to an emergency may not be operational due to damage, loss of power, etc.

In addition to being powered by solar energy via solar panels 110, the RFID-enhanced tower may also derive power from more traditional means, using a fuel powered generator 113 and optional connection device 115 for generator plug-in to power outlets. The included batteries 111 offer additional back-up power for use in cases of extreme weather conditions, natural disasters or other circumstances in which power is not available. The batteries 111 could also directly power other connected components such as a computer system.

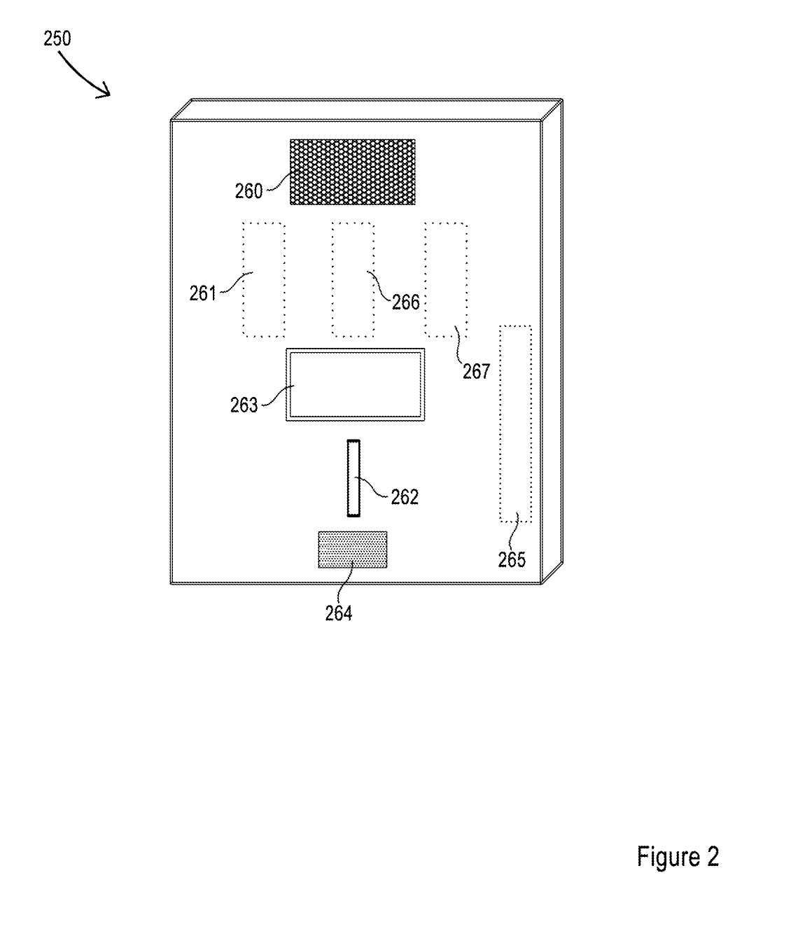

FIG. 2 illustrates a perspective view of an RFID personnel device (or “RFID tag”). The RFID personnel device 250 comprises a number of communication components including a speaker 260, an optional cellular chip 261, an LED indicator light 262, an SOS soft key 263, a microphone 264, an RFID antenna 266, and Bluetooth component 267. The RFID device 250 is powered by a battery supply 265. The RFID personnel device 250 is depicted in FIG. 2 as having a thick rectangular shape for illustrative purposes, but in practice it can take on a far slimmer form which enables it to be conveniently carried by employees/personnel at all times. The RFID personnel device 250's built-in RFID antenna 266 sends and receives signals to and from the RFID-enhanced solar tower 105 via a frequency spectrum that can utilize one of many available bandwidths as known in the art, such as 2.4 GHz or Z-Wave. Thus, the RFID antenna 266 can propagate a Bluetooth signal. The integration of a battery supply 265 powers the personnel device as an active RFID tag rather than a passive one, enhancing its reach over larger distances. At minimum, the personnel device 250 uses this signal to continuously broadcast the presence of its user in the structure, becoming a radio beacon to be picked up by the external tower.

Furthermore, any user with the device can press a backlit SOS soft key 263 which would initiate two-way communication with external personnel via microphone 264 and speaker 260. The LED indicator 262 can comprise one or two LED lights and can take the form of a battery level indicator or be used to relay a visual message to the trapped individual (e.g., that help is on the way). The Bluetooth component 267 allows for communication between the personnel device 250 and an individual's cellular phone or other mobile device. The RFID device worked for rescue or assistance, the user can press the SOS soft key 263, which causes the Bluetooth component 267 to initiate a call to the user's cellular phone (i.e. “ping” the cellular phone). If cellular coverage is available, the user's handset initiates a 911 call. If cellular coverage is not available, the RFID personnel device 250 can utilize a Voice Over Internet Protocol (VOIP) connection to the individual's cellular phone (which would include software configured to initiate a 911 phone call using an internet connection in lieu of using a wireless cellular service provider network).

The wireless internet connection (i.e. “wi-fi” connection) could be provided by the building/structure's internet service, or alternatively, by the RFID solar tower 105 (via the satellite backhaul 108 or landline broadband connection to provide the wi-fi signal to the RFID device and/or handset to provide the VOIP call. The solar tower 105 can be programmed with control features that allow only authorized cellular customers to utilize the connection to make VOIP calls. Utilizing a wireless spectrum would require the solar tower 105 to include carrier-specific spectrum equipment and would require but would require more bandwidth. When using the energy from the solar panels 110 and communication via satellite backhaul 108, the solar tower 105 is completely self-sustained. Thus, the RFID device and cellular phone would determine whether the traditional cellular network has service to complete the 911 call, and if not the VOIP functionality would provide back-up emergency communication. Thus, if the cellular service is out, emergency rescue personnel could call the unit using VOIP to initiate communications.

The two-way communication could also be integrated with other technologies, such as two-way radio (walkie-talkie), VOIP using Wi-Fi, in addition to cellular connection capabilities. Several levels of communication, both passive and active, are available. Thus, the system provides a consistent, real time stream of data relevant to the whereabouts of personnel following loss of power, building damage, catastrophic, collapse, etc. For example, once the emergency event occurs, the emergency personnel can identify who is in the structure as Tier 1, identify who has activated the SOS feature as Tier 2, and initiate two-way communication as Tier 3. One important reason for this feature is to assist emergency services in focusing on who is most likely still alive and trapped, which assures that critical time and resources are prioritized and not wasted looking for personnel who may have left the structure.

Apart from RFID communications, the personnel device 250 could provide access to a cellular network via its optional cellular chip 261. However, in lieu of requiring the user to subscribe to a wireless network, the device allows the user to utilize a Bluetooth or other wireless protocol chip 267 to link the device with their cellular phone as known in the art. With the integrated microphone 264 and speaker 260, two-way communication can be accomplished via the link to the user's cell phone. The personnel device 250 would be programmed to connect to the person's cell phone when the SOS soft key 263 on the device is triggered, which automatically directs the wireless phone to place an emergency call (E911). If the RFID device 250 is always connected to the wireless phone, the SOS soft key is what activates the phone to place the emergency call. Thus, the SOS button connects the Bluetooth chip to the cell phone to provide two-way communication. With this activation occurring via the SOS button, the device does not need to be turned off in order to use another Bluetooth device (e.g. a headset or car unit).

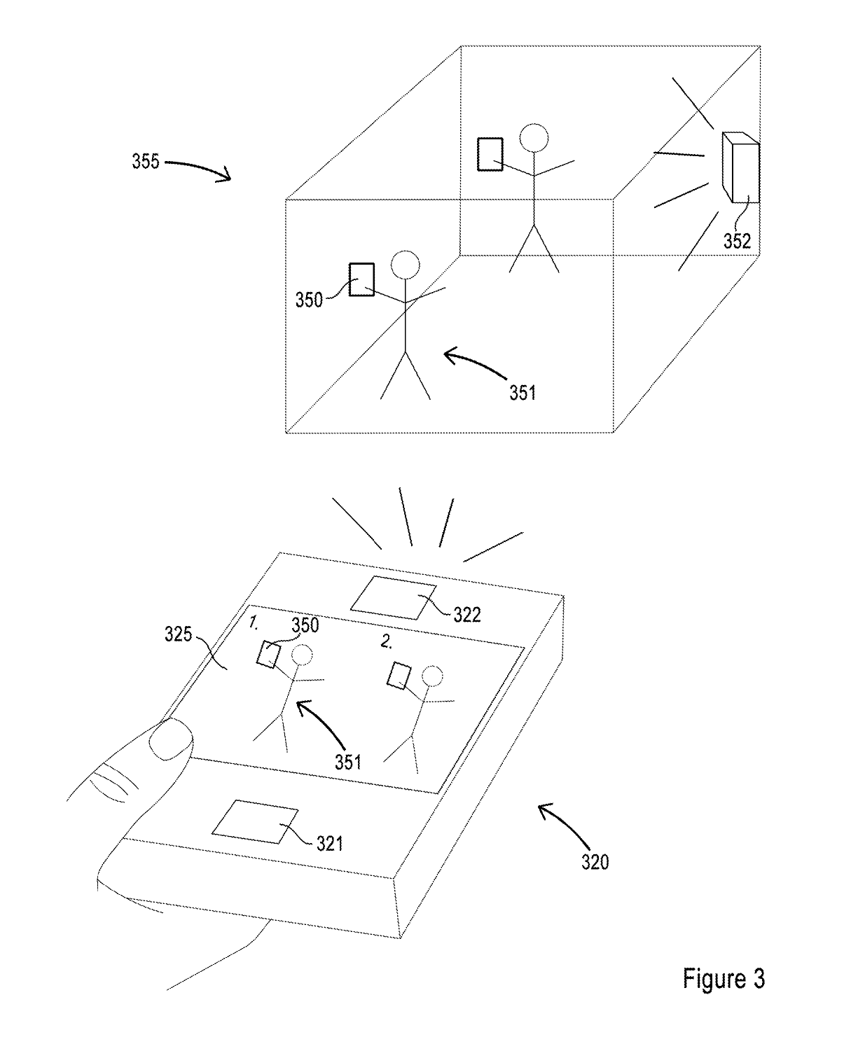

FIG. 3 illustrates a perspective view of both a mobile RFID device reader 320 and an RFID-ready building 355 with RFID device-equipped occupants 351. In almost any emergency situation, the value of mobility, and tactile simplicity with regard to monitoring stations/equipment handled by emergency responders is paramount. The RFID device reader 320 takes the essential features of the fixed tower and consolidates them into a user-friendly piece of hardware, taking the central processing unit out of the confines of a fixed location. The RFID reader 320 includes a display screen 325, as well as microphone 321 and speaker 322 to handle two-way communication. The display screen provides location/proximity information to allow rescuers to locate RFID device-equipped occupants 351 within the building 355 via their RFID devices 350. This proximity sensing operates as known in the art by sending an RF signal to the RFID device and determining its distance by the amount of time it takes to receive a return signal. Of course, the RFID device reader 320 is stored in an off-site location outside of the RFID-equipped building 355. The RFID device reader 320 and RFID personnel devices 350 can engage in two-way communication using VOIP. The RFID device reader can call the RFID device, or alternatively, the RFID device can be used to call the RFID device reader.

While there have been described herein what are considered to be preferred and exemplary embodiments of the present invention, other modifications of the invention shall be apparent to those skilled in the art from the teachings herein. For example, the relative dimensions of the device may be altered while keeping within the spirit and teachings of the invention. It is therefore desired to be secured, in the appended claims all such modifications as fall within the spirit and scope of the invention.

What is claimed is:

1. A communication system for emergency location of personnel in a building comprising:
an RFID repeater that extends an RF signal within a structure;
an RFID personnel device that is carried by personnel within said structure, said RFID personnel device further comprising a microphone, a speaker, a battery, an RFID antenna, LED indicator light, Bluetooth component and an SOS soft key;
an RFID-equipped solar tower, the solar tower comprising a plurality of solar panels, a cellular repeater, a satellite backhaul, and an RFID antenna; and
an RFID device reader further comprising a display screen, microphone, and speaker, said device reader providing two-way communication with the RFID personnel device via the SOS soft key, microphone, and speaker.

2. The communication system of claim 1 wherein the RFID personnel device further comprises a cellular chip that enables cellular communication.

3. The communication system of claim 1 wherein the RFID-equipped solar tower further comprises an emergency call box.

4. The communication system of claim 1 wherein pressing the SOS soft key of the RFID device provides a Bluetooth communication to a user's cellular handset to initiate a 911 emergency 911 call via a cellular network or VOIP network.

5. A communication system for emergency location of personnel in a building comprising:
an RFID repeater that extends an RF signal within a structure;
an RFID personnel device that is carried by personnel within said structure, said RFID personnel device further comprising a battery, an RFID antenna, LED indicator light, Bluetooth component and an SOS soft key;
an RFID-equipped solar tower, the solar tower comprising a plurality of solar panels, a cellular repeater, a satellite backhaul, and an RFID antenna; and
an RFID device reader, said device reader configured to identify receive communications sent via the SOS soft key.

6. The communication system of claim 5 wherein the RFID personnel device further comprises a cellular chip that enables cellular communication.

7. The communication system of claim 5 wherein the RFID-equipped solar tower further comprises an emergency call box.

8. The communication system of claim 5 wherein pressing the SOS soft key of the RFID device provides a Bluetooth communication to a user's cellular handset to initiate a 911 emergency 911 call via a cellular network or VOIP network.

9. A communication system for emergency location of personnel in a building comprising:
an RFID repeater that extends an RF signal within a structure;
an RFID personnel device that is carried by personnel within said structure, said RFID personnel device further comprising a battery, an RFID antenna, Bluetooth component and an SOS soft key;
an RFID-equipped solar tower, the solar tower comprising a plurality of solar panels, a cellular repeater, a satellite backhaul, and an RFID antenna; and
an RFID device reader further comprising a display screen and LED indicator light, the RFID device reader configured to display the location of the RFID personnel device within the structure and wherein the LED indicator light flashes upon activation of the SOS soft key.

10. The communication system of claim 9 wherein the RFID personnel device further comprises a Bluetooth component.

11. The communication system of claim 9 wherein the RFID personnel device further comprises a cellular chip that enables cellular communication.

12. The communication system of claim 9 wherein the RFID-equipped solar tower further comprises an emergency call box.

13. The communication system of claim 9 wherein pressing the SOS soft key of the RFID device provides a Bluetooth communication to a user's cellular handset to initiate a 911 emergency 911 call via a cellular network or VOIP network.
